(19) United States
(12) Patent Application Publication
(10) Pub. No.: US 2026/0186327 A1
(43) Pub. Date: Jul. 2, 2026

(54) ELECTRO-OPTIC PHASE SHIFTER, OPTICAL CHIP, METHOD FOR MANUFACTURING OPTICAL CHIP, AND LIDAR

(71) Applicant: Lunor Technology Co., Ltd., Beijing (CN)

(72) Inventors: Yi LI, Beijing (CN); Yang XU, Beijing (CN); Yongqiang DENG, Beijing (CN)

(73) Assignee: Lunor Technology Co., Ltd., Beijing (CN)

(21) Appl. No.: 19/434,000

(22) Filed: Dec. 29, 2025

(30) Foreign Application Priority Data
Dec. 31, 2024 (CN) 202411999410.1

(51) Int. Cl. G02F 1/01; G01S 17/32

(52) U.S. Cl. CPC G02F 1/011; G01S 17/32; G02F 2203/50

(57) ABSTRACT

The present application provides an electro-optical phase shifter, an optical chip, a method for manufacturing an optical chip, and a LiDAR, where the electro-optical phase shifter includes a ridge waveguide, a planar region located on at least one side of the ridge waveguide along a first direction, and an electrode region; where the planar region includes a connection section and a side section arranged in sequence along a second direction, and the electrode region is located on an outer side of the connection section along the first direction, the first direction and the second direction being perpendicular to each other; and along the second direction and on at least one side of the electrode region, an edge of the side section gradually approaches the ridge waveguide from the electrode region in a direction away from the electrode region.

### CROSS-REFERENCE TO RELATED APPLICATIONS

This application claims the priority benefit of China application no. 202411999410.1 filed on Dec. 31, 2024. The entirety of each of the above-mentioned patent applications is hereby incorporated by reference herein and made a part of this specification.

### TECHNICAL FIELD

The present application relates to the field of chip manufacturing technologies, and in particular, to an electro-optic phase shifter, an optical chip, a method for manufacturing an optical chip, and a LiDAR (Light Detection And Ranging).

### BACKGROUND

An electro-optic phase shifter is a critical component of a silicon-based optical phased array, which forms the core of a solid-state LiDAR. To meet the ranging requirement of a LiDAR, the scale and quantity of optical phased arrays in the LiDAR ranges from thousands to tens of thousands, and the quantity of electro-optic phase shifters and the quantity of optical antennas in an optical phased arrays are on the same order of magnitude. If the size of an optical phased array needs to be reduced, optional solutions include reducing spacing between the electro-optical phase shifters or reducing the size of the electro-optic phase shifter.

In related technologies, to reduce the spacing between the electro-optic phase shifters, positive electrode regions and negative electrode regions in a phase shifter are staggered along an extension direction of a waveguide, enabling the spacing between the phase shifters to be reduced to as little as 1 μm. However, a transition region of a ridge waveguide located between a positive electrode region and a negative electrode region has not been optimized accordingly with the staggered arrangement. Specifically, a width of the waveguide narrows sharply in the transition region and then widens sharply after the transition region, these two abrupt width changes of the waveguide introduce significant optical loss as light passes through the transition region. Additionally, a relatively large number of transition regions exist within the phase shifter, which may be located between the positive electrode regions and the negative electrode regions or may be located between adjacent periods, resulting in substantial optical loss in the phase shifter.

### SUMMARY

The objective of embodiments of the present application is to provide an electro-optical phase shifter, an optical chip, a method for manufacturing an optical chip, and a LiDAR, to solve the technical problem of the optical loss caused by the electrode staggered arrangement scheme used in the existing phase shifter.

To achieve the above objective, the technical solution adopted in the present application is:
providing an electro-optic phase shifter, including a ridge waveguide, a planar region located on at least one side of the ridge waveguide along a first direction, and an electrode region; where the planar region includes a connection section and a side section arranged in sequence along a second direction, and the electrode region is located on an outer side of the connection section along the first direction, the first direction and the second direction being perpendicular to each other; and
along the second direction and on at least one side of the electrode region, an edge of the side section gradually approaches the ridge waveguide from the electrode region in a direction away from the electrode region.

In some embodiments, on both sides of the electrode region, edges of the side sections gradually approach the ridge waveguide from the electrode region in directions away from the electrode region.

In some embodiments, the electro-optic phase shifter includes two planar regions and two electrode regions;
the two planar regions are located on both sides of the ridge waveguide along the first direction, two connection sections are spaced apart along the second direction, and the two electrode regions are located on outer sides of the two connection sections along the first direction, respectively.

In some embodiments, the side section includes a uniform region and a gradient region located between the uniform region and the connection section;
an edge of the gradient region gradually approaches the ridge waveguide from the electrode region in the direction away from the electrode region, and an edge of the uniform region is parallel to the ridge waveguide.

In some embodiments, a size of the connection section in the first direction is greater than or equal to a maximum size of the gradient region in the first direction.

In some embodiments, a size of the uniform region in the first direction is equal to a minimum size of the gradient region in the first direction.

In some embodiments, the edge of the side section is provided to be smooth.

In some embodiments, the phase shifter has n periods arranged along the second direction, where n≥2 and n is a positive integer; and in any two adjacent periods, edges of side sections between two adjacent electrode regions gradually approach the ridge waveguide from the electrode regions in directions away from the electrode regions.

The beneficial effect of the electro-optical phase shifter provided in the present application is as follows.

Compared with the existing technology, in the electro-optical phase shifter provided in the present application, the connection section and the side section of the planar region are arranged in sequence along the second direction, and the electrode region is located on an outer side of the connection section along the first direction. Along the second direction and on the at least one side of the electrode region, the edge of the side section gradually approaches the ridge waveguide from the electrode region in the direction away from the electrode region. Therefore, during the transmission of light in the second direction, since the edge of the side section gradually approaches the ridge waveguide from the electrode region in the direction away from the electrode region, that is, the overall edge of the planar region changes gently, there will be no sharp change when the light is transmitted from the connection section to the side section, and thus no excessive optical loss will be caused. Compared with the existing scheme, in which the planar region narrows sharply in width and then widens sharply, the optical loss can be greatly reduced.

Another objective of the present application is to provide an optical chip including the electro-optical phase shifter as described above.

The optical chip provided in the present application is applied with the electro-optical phase shifter provided in the present application. Due to the low optical loss of the electro-optical phase shifter provided in the present application, the optical loss of the optical chip can be reduced.

Another objective of the present application is to provide a LiDAR including the optical chip as described above or the electro-optical phase shifter as described above.

The LiDAR provided in the present application is applied with the electro-optical phase shifter or the optical chip provided in the present application. Due to the low optical loss of the electro-optical phase shifter and the optical chip provided in the present application, the internal loss of the LiDAR can be reduced.

Another objective of the present application is to provide a method for manufacturing an optical chip, including:
providing a substrate;
forming a semiconductor device layer on the substrate;
where the semiconductor device layer includes an electro-optic phase shifter, and the electro-optic phase shifter includes a ridge waveguide, a planar region located on at least one side of the ridge waveguide along a first direction, and an electrode region; where the planar region includes a connection section and a side section arranged in sequence along a second direction, and the electrode region is located on an outer side of the connection section along the first direction, the first direction and the second direction being perpendicular to each other; and along the second direction and on at least one side of the electrode region, an edge of the side section gradually approaches the ridge waveguide from the electrode region in a direction away from the electrode region.

The beneficial effect of the method for manufacturing an optical chip provided in the present application is as follows.

Compared with the existing technology, in the optical chip provided in the present application, a planar region includes a connection section and a side section arranged in sequence along the second direction; along the second direction and on the at least one side of the electrode region, the edge of the side section gradually approaches the ridge waveguide from the electrode region in the direction away from the electrode region, that is, the overall edge of the planar region changes gently. When light is transmitted from the connection section to the side section, there will be no sharp change, and thus no excessive optical loss will be caused. Compared with the existing scheme, in which the planar region narrows sharply in width and then widens sharply, the optical loss can be greatly reduced by the technical solution of the present application.

### BRIEF DESCRIPTION OF DRAWINGS

In order to provide a clearer explanation of the technical solution in the embodiments of the present application, a brief introduction will be given below to the drawings required for the description of the embodiments. It is obvious that the drawings described below are only some embodiments of the present application. Other drawings may be obtained based on these drawings without creative labor for the person of ordinary skill in the art.

FIG. 1 is a front view of a semiconductor layer of an existing electro-optic phase shifter.

FIG. 2 is a front view of a semiconductor layer of an electro-optic phase shifter provided in an embodiment of the present application.

FIG. 3 is a cross-sectional view taken along an A-A direction in FIG. 2.

FIG. 4 is a cross-sectional view taken along a B-B direction in FIG. 2.

FIG. 5 is a cross-sectional view taken along a C-C direction in FIG. 2.

FIG. 6 is a front view of an electro-optic phase shifter with multiple periods provided in an embodiment of the present application.

FIG. 7 is a front view of an electro-optical phase shifter provided in another embodiment of the present application.

FIG. 8 is a front view of an electro-optical phase shifter provided in yet another embodiment of the present application.

FIG. 9 is a front view of an electro-optical phase shifter provided in yet another embodiment of the present application.

FIG. 10 is a flowchart of a method for manufacturing an optical chip provided in an embodiment of the present application.

### DESCRIPTION OF EMBODIMENTS

In order to make the technical problem solved by the present application, the technical solution and the beneficial effect clearer and more understandable, further detailed explanations of the present application will be provided in conjunction with the accompanying drawings and the embodiments. It should be understood that the specific embodiments described herein are only used to explain the present application and are not intended to limit the present application.

It should be noted that when a component is referred to as being “fixed to” or “arranged on” another component, it may be directly or indirectly on such another component. When a component is referred to as being “connected” to another component, it may be directly or indirectly connected to such another component.

It should be understood that directional or positional relationships indicated by the terms “length”, “width”, “up”, “down”, “front”, “back”, “left”, “right”, “vertical”, “horizontal”, “top”, “bottom”, “inside”, “outside”, etc., are based on the directional or positional relationships shown in the accompanying drawings, and are only for the convenience of describing the present application and for simplifying description, and do not indicate or imply that the apparatus or component referred to must have a specific orientation, or be constructed and operated in a specific orientation, and therefore cannot be understood as a limitation on the present application.

In addition, the terms “first” and “second” are only used for descriptive purposes and cannot be understood as indicating or implying the importance of the connection or implying the quantity of technical features indicated. Thus, a feature described as “first” or “second” may explicitly or implicitly that one or more said features are included. In the description of the present application, the meaning of “multiple” refers to two or more, unless otherwise specifically limited.

Now, an explanation will be given of an electro-optical phase shifter, an optical chip, a method for manufacturing an optical chip, and a LiDAR provided in the embodiments of the present application.

Please refer to FIG. 2 to FIG. 9. An electro-optical phase shifter provided in an embodiment of the present application includes a ridge waveguide 100, a planar region 200 located on at least one side of the ridge waveguide 100 along a first direction, and an electrode region 300. The planar region 200 includes a connection section 201 and a side section 202 arranged in sequence along a second direction. The electrode region 300 is located on an outer side of the connection section 201 along the first direction, the first direction and the second direction being perpendicular to each other.

Along the second direction and on at least one side of the electrode region 300, an edge of the side section 202 gradually approaches a centerline of the ridge waveguide 100 from the electrode region 300 in a direction away from the electrode region 300.

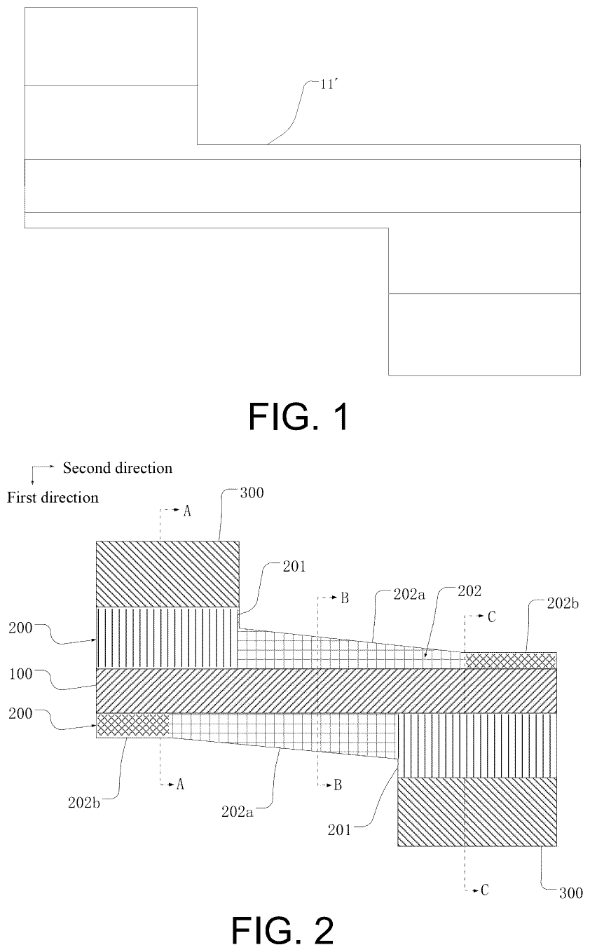

As a comparison, in the phase shifter shown in FIG. 1, a width of a waveguide narrows sharply in a transition region 11′ and then widens sharply after the transition region 11′, and these two abrupt width changes of the waveguide introduce significant optical loss as light passes through the transition region 11′.

As shown in FIG. 2, in the electro-optical phase shifter provided in the embodiment of the present application, the connection section 201 and the side section 202 of the planar region 200 are arranged in sequence along the second direction, and the electrode region 300 is located on an outer side of the connection section 201 along the first direction. Along the second direction and on the at least one side of the electrode region 300, the edge of side section 202 gradually approaches the ridge waveguide 100 from the electrode region 300 in the direction away from the electrode region 300.

Therefore, during the transmission of light in the second direction, since the edge of the side section gradually approaches the ridge waveguide from the electrode region in the direction away from the electrode region, that is, the overall edge of the planar region changes gently, there will be no sharp change when the light is transmitted from the connection section to the side section, and thus no excessive optical loss will be caused. Compared with the existing scheme, in which the planar region narrows sharply in width and then widens sharply, the optical loss can be greatly reduced.

In some embodiments, on both sides of the electrode region 300, edges of side sections 202 gradually approach the ridge waveguide 100 from the electrode region 300 in directions away from electrode region 300. Along the transmission direction of the light, the overall edge of the planar region changes gently. When the light is transmitted from a connection section to a side section, and then transmitted from the side section to a connection section, there will be no sharp change, and thus no excessive optical loss will be caused.

In some embodiments, the electro-optic phase shifter includes two planar regions 200 and two electrode regions 300. The two planar regions 200 are located on both sides of the ridge waveguide 100 along the first direction, and the two connection sections 201 are spaced apart along the second direction. The two electrode regions 300 are located on outer sides of the two connection sections 201 along the first direction.

Along the transmission direction of the light, the overall edges of the planar regions on both sides along the first direction change gently. When the light is transmitted from a connection section to a side section, and then transmitted from the side section to a connection section, there will be no sharp change, and thus no excessive optical loss will be caused.

In this embodiment, the ridge waveguide 100 extends with a length size in the second direction and a width size along the first direction, where the width size remains constant throughout an entire period. Gradient setting is applied to the edge of the side section 202 of the planar region 200 to minimize the loss of light transmitted from the connection section 201 to the side section 202.

In some embodiments, the side section 202 includes a uniform region 202b and a gradient region 202a located between the uniform region 202b and the connection section 201. An edge of the gradient region 202a gradually approaches the ridge waveguide 100 from the electrode region 300 in the direction away from the electrode region 300, and an edge of the uniform region 202b is parallel to the ridge waveguide 100, that is, width sizes of the uniform region 202b are provided to be uniform in the first direction.

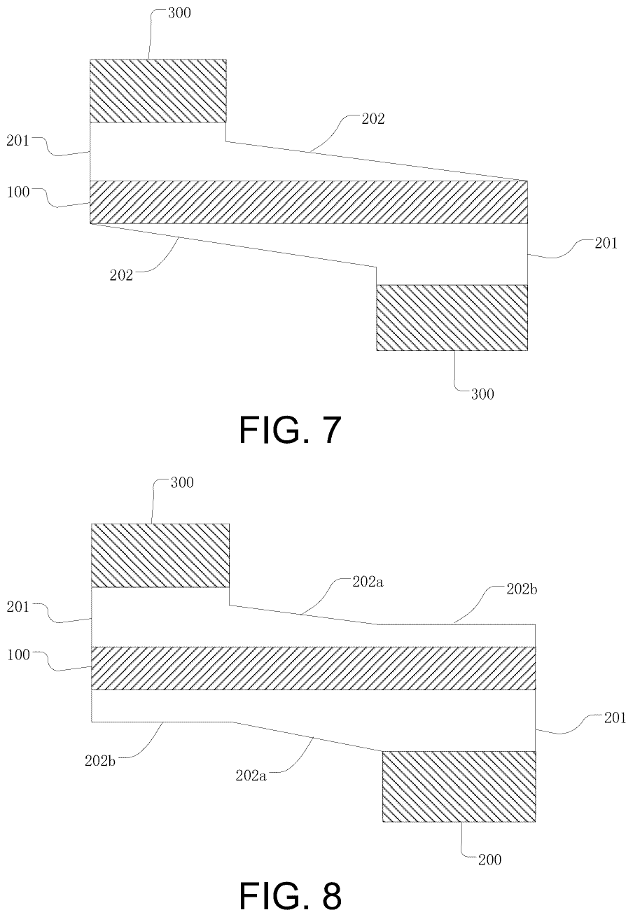

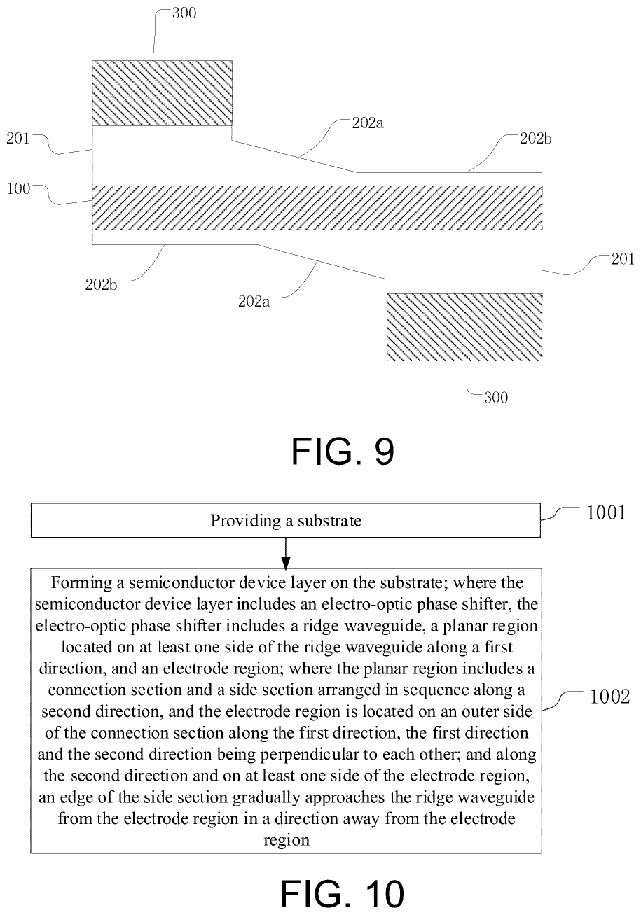

In some embodiments, in the second direction, the size of a portion, located between two electrode regions 300 along the second direction, of the ridge waveguide 100 is smaller than that of the gradient region 202a. As shown in FIG. 7, in some embodiments, the side section 202 may also be provided as a whole gradient, that is, the shape of the entire side section 202 is provided to be consistence with that of the gradient region 202a provided in the above embodiments. As shown in FIG. 8, in some embodiments, in the second direction, the size of a portion, located between two electrode regions 300 along the second direction, of the ridge waveguide 100 is exactly equal to that of the gradient region 202a. Obviously, as shown in FIG. 9, in the second direction, the size of a portion, located between two electrode regions 300 along the second direction, of the ridge waveguide 100 is larger than that of the gradient region 202a.

In some embodiments, a size of the connection section 201 in the first direction is greater than or equal to a maximum size of the gradient region 202a in the first direction. In some specific embodiments, the size of the connection section 201 in the first direction is greater than the maximum size of the gradient region 202a in the first direction. In this way, by adopting the staggered configuration of the two electrode regions, the spacing between phase shifters can be reduced by staggered arrangement, and the optical loss can be reduced by introducing the gradient region 202a.

In some embodiments, a size of the uniform region 202b in the first direction is equal to a minimum size of the gradient region 202a in the first direction, so that side edges of the planar region 200 along the first direction can transition smoothly, thereby reducing the optical loss. Obviously, in another embodiment, the size of the uniform region 202b in the first direction may be slightly greater or smaller than the minimum size of the gradient region 202a in the first direction.

In some embodiments, a size of the ridge waveguide 100 in a thickness direction is identical with a size of the electrode region 300 in the thickness direction, and a size of the planar region 200 in the thickness direction is smaller than sizes of the ridge waveguide 100 and the electrode region 300 in the thickness direction.

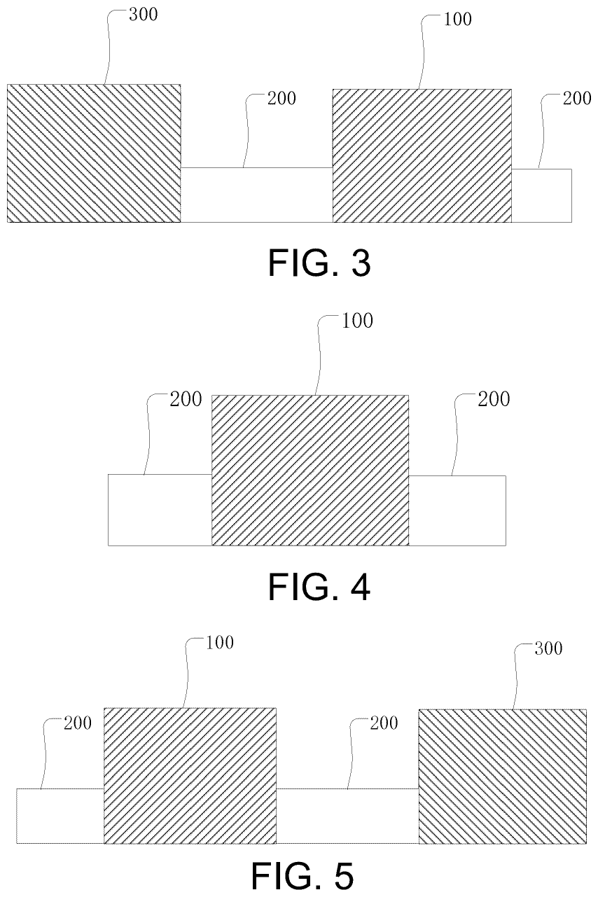

In some embodiments, as shown in FIG. 3 and FIG. 4, the edge of the side section 202 is provided to be smooth, for example, it may be provided in an inclined straight line shape or in an arc shape. In another embodiment, the edge of the side section 202 may also be provided in a stepped shape.

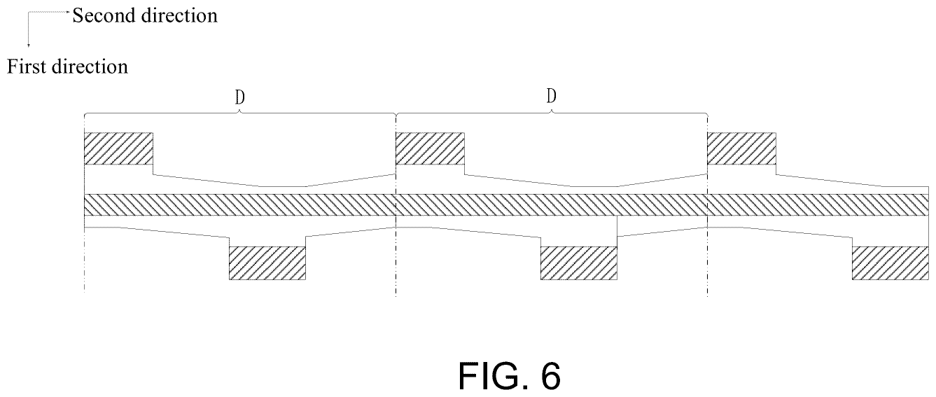

As shown in FIG. 6, in some embodiments, the phase shifter has n periods arranged along the second direction, where n≥2 and n is a positive integer; and in any two adjacent periods, edges of side sections between two adjacent electrode regions 300 gradually approach the ridge waveguide 100 from the electrode regions in directions away from the electrode regions 300. During the transmission of light in the second direction, due to the relatively gentle changes of side sections between adjacent electrode regions 300 in adjacent periods, no excessive optical loss will be caused. Compared with the existing scheme, in which the planar region narrows sharply in width and then widens sharply, the optical loss can be greatly reduced.

Another objective of the present application is to provide an optical chip including the electro-optical phase shifter as described above.

The optical chip provided in the present application is applied with the electro-optical phase shifter provided in the present application. Due to the low optical loss of the electro-optical phase shifter provided in the present application, the optical loss of the optical chip can be reduced.

Another objective of the present application is to provide a LiDAR including the optical chip as described above or the electro-optical phase shifter as described above.

The LiDAR provided in the present application is applied with the electro-optical phase shifter or the optical chip provided in the present application. Due to the low optical loss of the electro-optical phase shifter and the optical chip provided in the present application, the internal loss of the LiDAR can be reduced.

As shown in FIG. 10, another objective of the embodiments in the present application is to provide a method for manufacturing an optical chip, including:
1001, providing a substrate; specifically, the substrate may be a commonly used SOI (Silicon-On-Insulator) substrate;
1002, forming a semiconductor device layer on the substrate;
where the semiconductor device layer includes an electro-optic phase shifter, the electro-optic phase shifter includes a ridge waveguide, a planar region located on at least one side of the ridge waveguide along a first direction, and an electrode region; where the planar region includes a connection section and a side section arranged in sequence along a second direction, and the electrode region is located on an outer side of the connection section along the first direction, the first direction and the second direction being perpendicular to each other; and along the second direction and on at least one side of the electrode region, an edge of the side section gradually approaches the ridge waveguide from the electrode region in a direction away from the electrode region. It can be understood that the electro-optic phase shifter refers to the optical chip in the aforementioned embodiments.

In the method for manufacturing the optical chip provided in an embodiment of the present application, along the second direction and on the at least one side of the electrode region, the edge of the side section gradually approaches the ridge waveguide from the electrode region in the direction away from the electrode region, that is, the overall edge of the planar region changes gently. When light is transmitted from the connection section to the side section, there will be no sharp change, and thus no excessive optical loss will be caused. Compared with the existing scheme, in which the planar region narrows sharply in width and then widens sharply, the optical loss can be greatly reduced.

The ridge waveguide, the planar region, and the electrode region may be formed by etching, including but not limited to wet etching and dry etching. The wet etching may be classified into isotropic etching and anisotropic etching, which depends on etching rates along different crystal orientations in the etching solution. Dry etching employs either a physical method (such as sputtering, ion etching) or a chemical method (such as reactive ion etching).

The above are only preferred embodiments of the present application and are not used to limit the present application. Any modifications, equivalent substitutions, and improvements, etc., made within the spirit and principles of the present application should be included within the protection scope of the present application.

Among them, reference numbers in the drawings are:
100, Ridge waveguide; 200, Planar region; 300, Electrode region;
201, Connection section; 202, Side section;
202a, Gradient region; 202b, Uniform region.

What is claimed is:

1. An electro-optical phase shifter, wherein
the electro-optic phase shifter comprises a ridge waveguide, a planar region located on at least one side of the ridge waveguide along a first direction, and an electrode region; wherein the planar region comprises a connection section and a side section arranged in sequence along a second direction, and the electrode region is located on an outer side of the connection section along the first direction, the first direction and the second direction being perpendicular to each other; and
along the second direction and on at least one side of the electrode region, an edge of the side section gradually approaches the ridge waveguide from the electrode region in a direction away from the electrode region.

2. The electro-optical phase shifter according to claim 1, wherein
on both sides of the electrode region, edges of the side sections gradually approach the ridge waveguide from the electrode region in directions away from the electrode region.

3. The electro-optical phase shifter according to claim 1, wherein
the electro-optic phase shifter comprises two planar regions and two electrode regions;
the two planar regions are located on both sides of the ridge waveguide along the first direction, two connection sections are spaced apart along the second direction, and the two electrode regions are located on outer sides of the two connection sections along the first direction, respectively.

4. The electro-optical phase shifter according to claim 1, wherein
the side section comprises a uniform region and a gradient region located between the uniform region and the connection section;
an edge of the gradient region gradually approaches the ridge waveguide from the electrode region in the direction away from the electrode region, and an edge of the uniform region is parallel to the ridge waveguide.

5. The electro-optical phase shifter according to claim 2, wherein
the side section comprises a uniform region and a gradient region located between the uniform region and the connection section;
an edge of the gradient region gradually approaches the ridge waveguide from the electrode region in the direction away from the electrode region, and an edge of the uniform region is parallel to the ridge waveguide.

6. The electro-optical phase shifter according to claim 3, wherein
the side section comprises a uniform region and a gradient region located between the uniform region and the connection section;
an edge of the gradient region gradually approaches the ridge waveguide from the electrode region in the direction away from the electrode region, and an edge of the uniform region is parallel to the ridge waveguide.

7. The electro-optical phase shifter according to claim 4, wherein
a size of the connection section in the first direction is greater than or equal to a maximum size of the gradient region in the first direction.

8. The electro-optical phase shifter according to claim 5, wherein
a size of the connection section in the first direction is greater than or equal to a maximum size of the gradient region in the first direction.

9. The electro-optical phase shifter according to claim 6, wherein
a size of the connection section in the first direction is greater than or equal to a maximum size of the gradient region in the first direction.

10. The electro-optical phase shifter according to claim 4, wherein
a size of the uniform region in the first direction is equal to a minimum size of the gradient region in the first direction.

11. The electro-optical phase shifter according to claim 5, wherein
a size of the uniform region in the first direction is equal to a minimum size of the gradient region in the first direction.

12. The electro-optical phase shifter according to claim 6, wherein
a size of the uniform region in the first direction is equal to a minimum size of the gradient region in the first direction.

13. The electro-optical phase shifter according to claim 1, wherein
the edge of the side section is provided to be smooth, and gradually approaches the ridge waveguide from the electrode region in a direction away from the electrode region.

14. The electro-optical phase shifter according to claim 2, wherein
the edge of the side section is provided to be smooth.

15. The electro-optical phase shifter according to claim 3, wherein
the edge of the side section is provided to be smooth.

16. The electro-optical phase shifter according to claim 3, wherein
the electro-optical phase shifter has n periods arranged along the second direction, wherein n≥2 and n is a positive integer; and in any two adjacent periods, edges of side sections between two adjacent electrode regions gradually approach the ridge waveguide from the electrode regions in directions away from the electrode regions.

17. An optical chip, wherein
the optical chip comprises an electro-optic phase shifter, wherein the electro-optic phase shifter comprises a ridge waveguide, a planar region located on at least one side of the ridge waveguide along a first direction, and an electrode region; wherein the planar region comprises a connection section and a side section arranged in sequence along a second direction, and the electrode region is located on an outer side of the connection section along the first direction, the first direction and the second direction being perpendicular to each other; and
along the second direction and on at least one side of the electrode region, an edge of the side section gradually approaches the ridge waveguide from the electrode region in a direction away from the electrode region.

18. A LiDAR (Light Detection And Ranging), wherein
the LiDAR comprises the electro-optical phase shifter according to claim 1.

19. A LiDAR, wherein
the LiDAR comprises the optical chip according to claim 17.

20. A method for manufacturing an optical chip, comprising:
providing a substrate;
forming a semiconductor device layer on the substrate;
wherein the semiconductor device layer comprises an electro-optic phase shifter, and the electro-optic phase shifter comprises a ridge waveguide, a planar region located on at least one side of the ridge waveguide along a first direction, and an electrode region; wherein the planar region comprises a connection section and a side section arranged in sequence along a second direction, and the electrode region is located on an outer side of the connection section along the first direction, the first direction and the second direction being perpendicular to each other; and along the second direction and on at least one side of the electrode region, an edge of the side section gradually approaches the ridge waveguide from the electrode region in a direction away from the electrode region.
